(19) United States
(12) Patent Application Publication
(10) Pub. No.: US 2025/0055317 A1
(43) Pub. Date: Feb. 13, 2025

(54) ELECTRONIC DEVICE FOR CHARGING WEARABLE DEVICE

(71) Applicant: Samsung Electronics Co., Ltd., Suwon-si (KR)

(72) Inventors: Kukhwan KIM, Suwon-si (KR); Jaehyung HONG, Suwon-si (KR)

(21) Appl. No.: 18/735,764

(22) Filed: Jun. 6, 2024

Related U.S. Application Data
(63) Continuation of application No. PCT/KR2024/005709, filed on Apr. 26, 2024.

(30) Foreign Application Priority Data
Aug. 7, 2023 (KR) 10-2023-0103207

(51) Int. Cl. H02J 50/00; H02J 50/10

(52) U.S. Cl. CPC H02J 50/005; H02J 50/10

(57) ABSTRACT

According to an embodiment, an electronic device for charging a wearable device includes a housing including a guide hole, and an elastic structure configured to supply power to the wearable device. The elastic structure includes a first portion at least partially disposed in the guide hole, a second portion rotatably coupled with the housing, and a third portion connecting the first portion and the second portion. The third portion is deformed by a rotation of the second portion such that the third portion is configured to change a distance between a rotation axis of the second portion and one position of the third portion.

### CROSS-REFERENCE TO RELATED APPLICATION(S)

This application is a continuation application, claiming priority under § 365 (c), of an International application No. PCT/KR2024/005709, filed on Apr. 26, 2024, which is based on and claims the benefit of a Korean patent application number 10-2023-0103207, filed on Aug. 7, 2023, in the Korean Intellectual Property Office, the disclosure of which is incorporated by reference herein in its entirety.

### TECHNICAL FIELD

The disclosure relates to an electronic device for charging a wearable device.

### BACKGROUND ART

A wearable device may be used in a state of being worn on a part of a user's body. The wearable devices may be provided in various types of products. For example, the wearable device may include a ring-shaped device to be worn on the part of the user's body. The wearable device may be provided in various sizes to the user in order to meet the user's request. An electronic device for charging the wearable device may require a structure for charging the wearable device provided in various sizes.

The above-described information may be provided as a related art for the purpose of helping understand the disclosure. No argument or decision is made as to whether any of the above-described content may be applied as a prior art in connection with the disclosure.

### DISCLOSURE

### Technical Solution

Aspects of the disclosure are to address at least the above-mentioned problems and/or disadvantages and to provide at least the advantages described below. Accordingly, an aspect of the disclosure is to provide an electronic device for charging a wearable device.

Additional aspects will be set forth in part in the description which follows and, in part, will be apparent from the description, or may be learned by practice of the presented embodiments.

In accordance with an aspect of the disclosure, an electronic device for charging a wearable device is provided. The electronic device includes a housing including a guide hole, and an elastic structure coupled on the housing and configured to supply power to the wearable device. The elastic structure may include a first portion at least partially disposed in the guide hole, a second portion rotatably coupled with the housing, and a third portion, which is deformable, connecting the first portion and the second portion. The third portion may be deformed by a rotation of the second portion such that the third portion is configured to change a distance between a rotation axis of the second portion and one position of the third portion.

In accordance with another aspect of the disclosure, an electronic device for charging wearable device is provided. The electronic device includes a housing including a guide hole, and an elastic structure coupled on the housing and configured to supply power to the wearable device. The elastic structure may include a first portion at least partially disposed in the guide hole, and a second portion rotatably coupled with the housing. The elastic structure may include a third portion connecting the first portion and the second portion and including a first region connected to the second portion and having a radius of curvature within a first reference range from the rotation axis of the second portion, and a second region extending from the first region to the first portion and having a radius of curvature within a second reference range from the rotation axis greater than the radius of curvature within the first reference range. The third portion may be deformed by a rotation of the second portion such that the third portion is configured to change a distance between a rotation axis of the second portion and one position of the third portion is changeable. The first portion may be slidable along the guide hole by the rotation of the second portion.

Other aspects, advantages, and salient features of the disclosure will become apparent to those skilled in the art from the following detailed description, which, taken in conjunction with the annexed drawings, discloses various embodiments of the disclosure.

### DESCRIPTION OF THE DRAWINGS

FIGS. 1A, 1B, and 1C illustrate an electronic device for charging an exemplary wearable device.

FIG. 2A is a top plan view of an electronic device in an exemplary first state.

FIG. 2B is a top plan view of an electronic device in an exemplary second state.

FIG. 3A is an exploded perspective view of an exemplary electronic device.

FIG. 3B illustrates an exemplary electronic device of FIG. 3A.

FIG. 4A is an exploded perspective view of an exemplary electronic device.

FIG. 4B illustrates an exemplary electronic device of FIG. 4A.

FIGS. 5A, 5B, and 5C are a top plan view of an exemplary electronic device.

FIG. 6 is a block diagram of an exemplary electronic device.

### MODE FOR INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

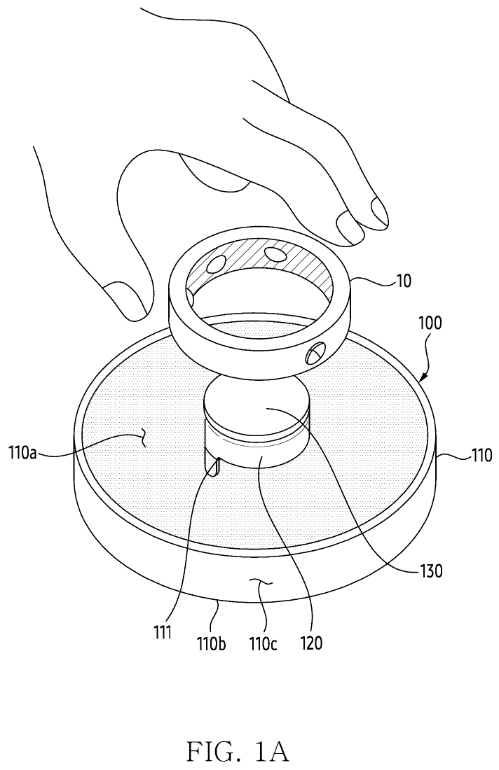

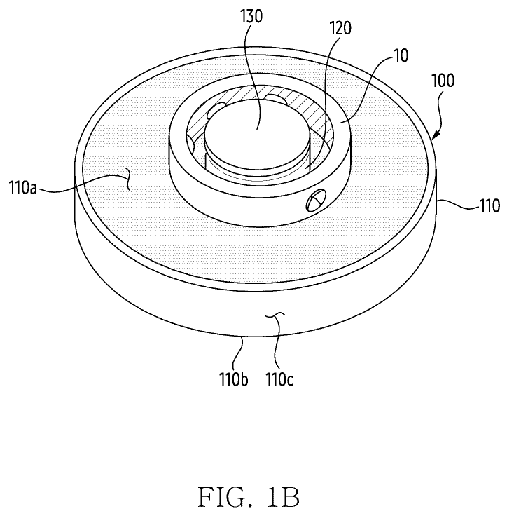

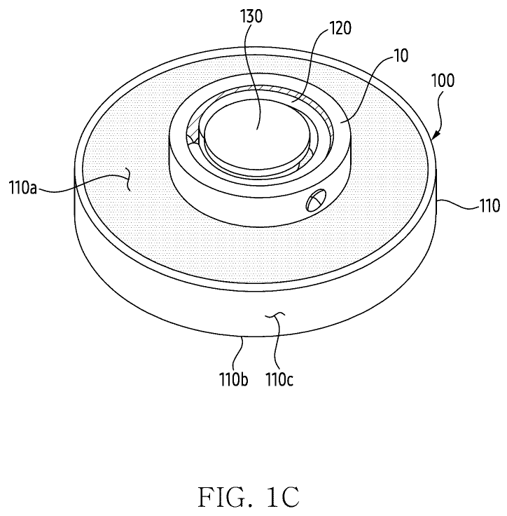

FIGS. 1A, 1B, and 1C illustrate an electronic device for charging an exemplary wearable device.

Referring to FIGS. 1A, 1B, and 1C, an electronic device 100 for charging a wearable device 10 may include a housing 110 and an elastic structure 120. The electronic device 100 may be referred to as a charging device for charging the wearable device 10. The electronic device 100 may supply power to the wearable device 10.

According to an embodiment, the wearable device 10 may be worn by a user. The user may mean a person who wears the wearable device 10. The wearable device 10 may be worn on a part of the user's body. For example, the wearable device 10 may be worn on the part of the user's body. For example, the wearable device 10 may be fastened to the part of the user's body. For example, the wearable device 10 may be detachable with respect to the part of the user's body.

For example, the wearable device 10 may be in contact with the part of the user's body by being worn by the user. For example, the wearable device 10 may be configured to obtain information related to the user through the part of the user's body by being worn by the user. For example, the wearable device 10 may provide information indicating the user's state to the user, based on obtaining the information related to the user. For example, the wearable device 10 may provide the information indicating the user's state to the user, by being configured to display the information indicating the user's state through a display (not illustrated) of the wearable device 10 and/or an external electronic device (not illustrated) connected to the wearable device 10. However, it is not limited thereto.

For example, the part of the user's body on which the wearable device 10 is worn may be the user's finger. For example, the wearable device 10 may have a ring shape so that the wearable device 10 is worn on the user's finger. However, it is not limited thereto. The wearable device 10, which may be referred to as a wearable device, may have a shape corresponding to the part of the body in order to be worn on the part of the user's body.

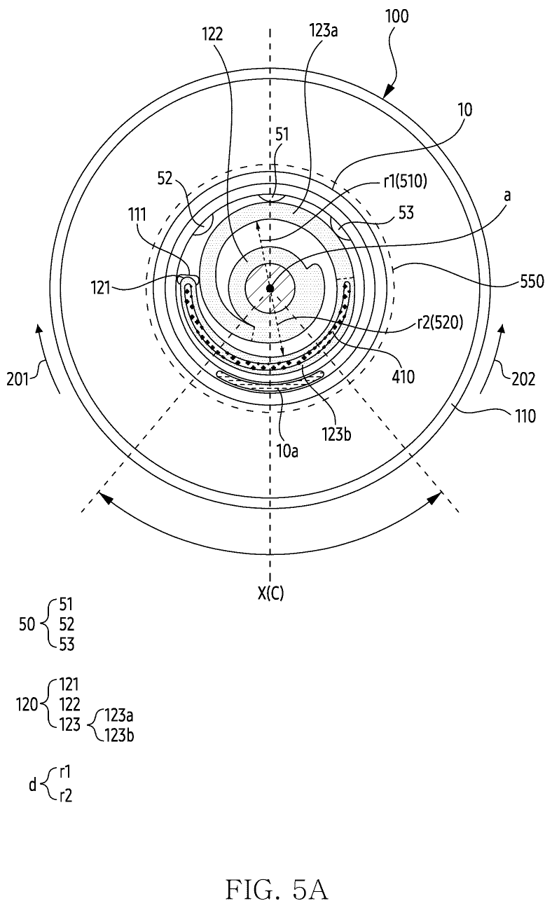

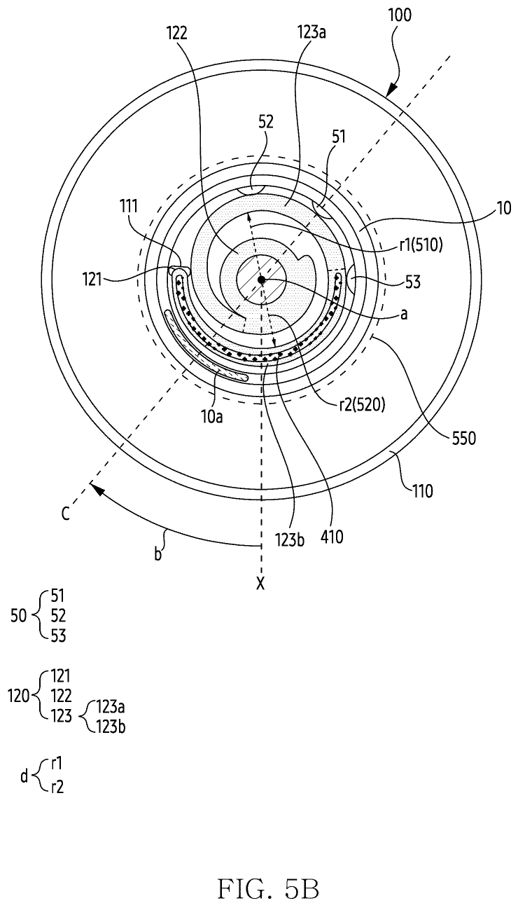

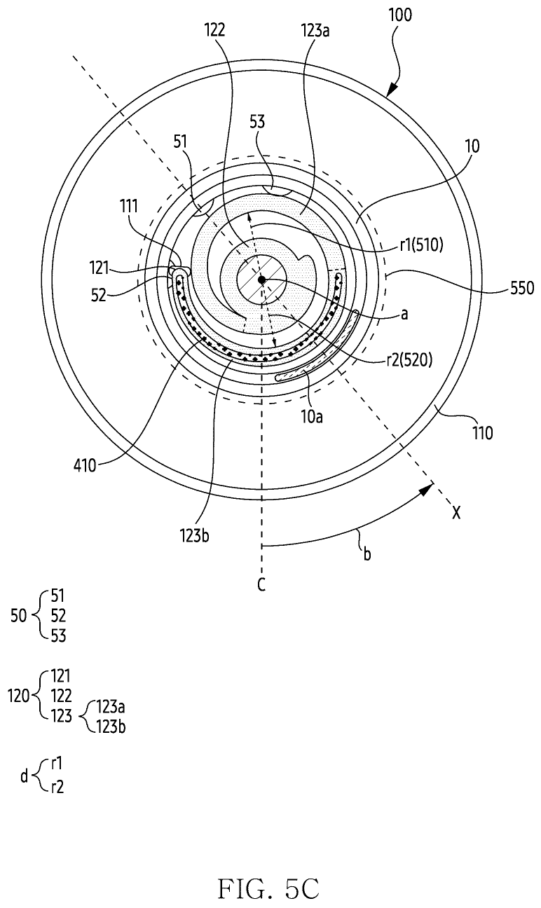

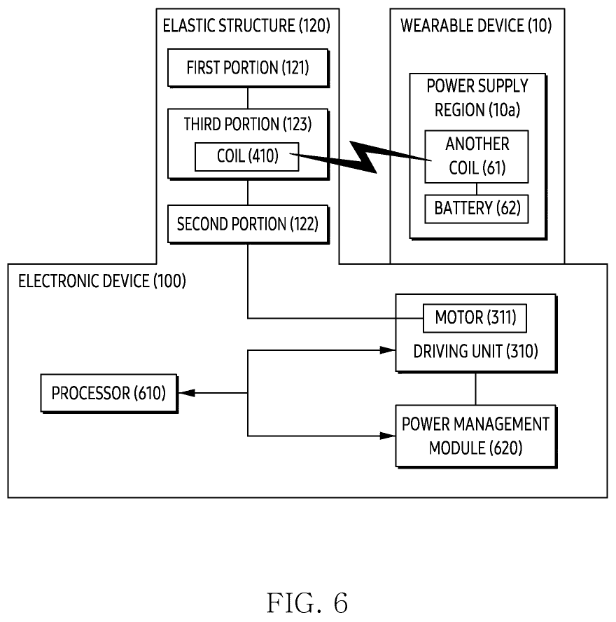

According to an embodiment, the electronic device 100 may be configured to charge the wearable device 10. For example, the electronic device 100 may supply power to the electronic device 100 through wireless charging by being in contact with at least the portion of the wearable device 10. For example, although not illustrated, the electronic device 100 may include a coil (e.g., coil 410 of FIG. 5B) for charging the wearable device 10. The wearable device 10 may be configured to supply power to the coil 410. The coil 410 to which power is supplied may be configured to allow current to flow in another coil (e.g., another coil 61 of FIG. 6) adjacent to the coil 410 through electromagnetic induction with the other coil 61 in the wearable device 10. As the current flows in the other coil 61, a battery (e.g., a battery 62 of FIG. 6) in the wearable device 10 may be charged. However, it is not limited thereto.

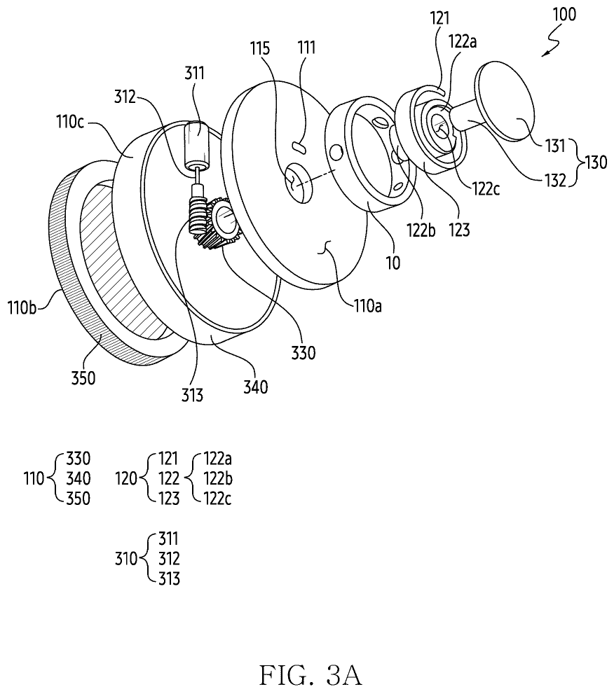

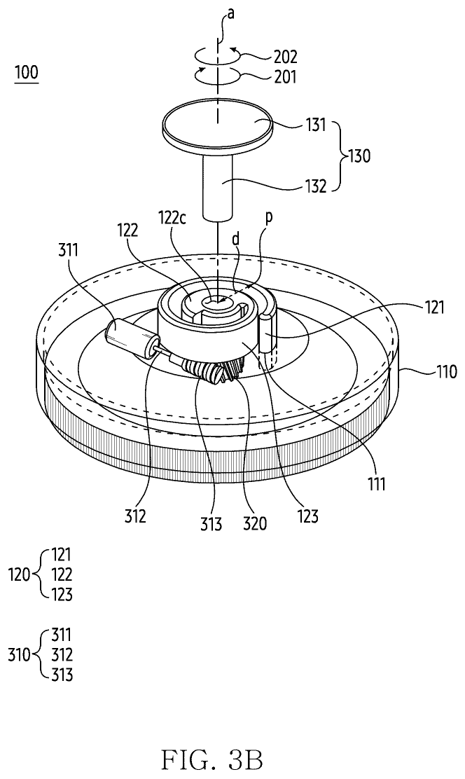

According to an embodiment, the housing 110 may include a first surface 110a, a second surface 110b opposite to the first surface 110a, and a third surface 110c surrounding a space between the first surface 110a and the second surface 110b. For example, the first surface 110a may be a surface on which the wearable device 10 is mounted. For example, the first surface 110a may be a surface on which the elastic structure 120 for charging the wearable device 10 is disposed. For example, the first surface 110a may be a surface to which the elastic structure 120 is coupled among the housing 110. For example, the second surface 110b may be a surface facing the first surface 110a and spaced apart from the first surface 110a. For example, the second surface 110b may be a surface supporting the housing 110. For example, the third surface 110c may be extended from the first surface 110a to the second surface 110b. For example, the third surface 110c may be disposed between the first surface 110a and the second surface 110b. For example, the third surface 110c may surround a space between the first surface 110a and the second surface 110b. At least one electronic component (e.g., a motor 311 of FIG. 3A) of the electronic device 100 may be disposed in the space, but is not limited thereto.

According to an embodiment, the housing 110 may include a guide hole 111. For example, the guide hole 111 may penetrate at least a portion of the housing 110. For example, the guide hole 111 may be formed on the first surface 110a on which the wearable device 10 is mounted. For example, the guide hole 111 may penetrate the first surface 110a. For example, the guide hole 111 may be connected from the first surface 110a to a space surrounded by the first surface 110a, the second surface 110b, and the third surface 110c of the housing 110. For example, the guide hole 111 may accommodate at least a portion of the elastic structure 120. For example, the guide hole 111 may be coupled with the elastic structure 120. For example, the guide hole 111 may guide a movement of at least a portion of the elastic structure 120. The housing 110 may reduce the elastic structure 120 for charging the wearable device 10 from being separated from the housing 110 by including the guide hole 111.

According to an embodiment, the elastic structure 120 may be coupled on the housing 110. The elastic structure 120 may be configured to supply power to the wearable device 10.

For example, the elastic structure 120 may be connected to the housing 110. For example, the elastic structure 120 may be coupled on the first surface 110a of the housing 110. For example, the elastic structure 120 may be assembled on the housing 110 by being at least partially disposed in the guide hole 111 of the housing 110. For example, a portion of the elastic structure 120 may be disposed inside the housing 110 through the guide hole 111 of the housing 110. The remaining portion of the elastic structure 120 may be exposed to the outside of the housing 110 and may be in contact with the first surface 110a of the housing 110.

For example, although not illustrated, the elastic structure 120 may include the coil 410 for charging the wearable device 10. The coil 410 may be disposed inside the elastic structure 120. For example, the elastic structure 120 may be configured to charge the wearable device 10 by being in contact with at least a portion of the wearable device 10. For example, a portion of the elastic structure 120 in which the coil 410 is disposed may be in contact with a power supply region (e.g., a power supply region 10a of FIG. 5A) of the wearable device 10 in which the other coil 61 of the wearable device 10 is disposed. The coil 410 may be configured to generate an induced current in the other coil 61 through electromagnetic induction with the other coil 61, by being disposed adjacent to the other coil 61. As the current flows through the other coil 61 in the wearable device 10, the wearable device 10 may be charged.

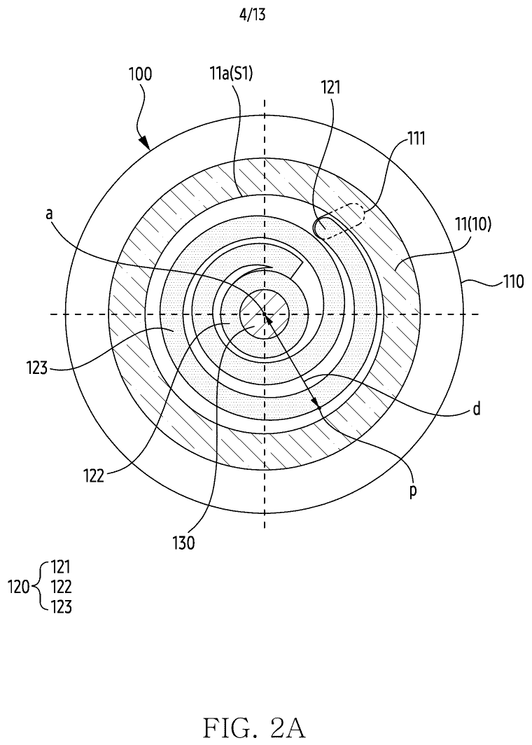

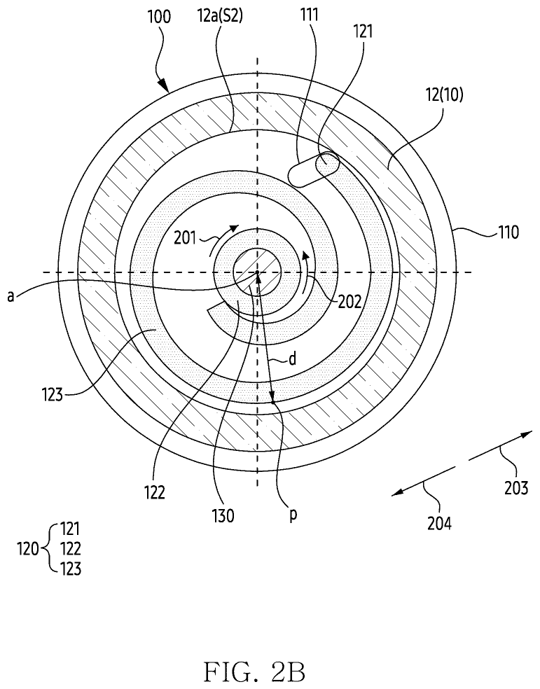

For example, the wearable device 10 may have the ring shape in order to be worn on the part of the user's body (e.g., a finger). Since a size of the part of the user's body in which the wearable device 10 is worn varies according to the user wearing the wearable device 10, a size of the wearable device 10 having the ring shape and/or a size of an inner circumference of the wearable device 10 may vary. The elastic structure 120 of the electronic device 100 may require a changeable structure in response to the size of the wearable device 10 that varies according to the size of the part of the user's body. For example, at least a portion of the elastic structure 120 may be deformed to be in contact with an inner circumference surface of the wearable device 10 mounted on the first surface 110a of the housing 110. The elastic structure 120 may increase charging efficiency of the wearable device 10 by being in contact with at least a portion of the wearable device 10. A change in the elastic structure 120 will be described later in FIGS. 2A and 2B.

According to an embodiment, the elastic structure 120 may include at least one of rubber and spring. The elastic structure 120 may be at least partially elastically deformed by including at least one of the rubber and the spring. The elastic structure 120 may be in contact with the wearable device 10 mounted on the housing 110, by being deformable. The elastic structure 120 may increase charging efficiency of the wearable device 10 by being in contact with the wearable device 10.

According to an embodiment, the electronic device 100 may further include a guide structure 130 for guiding a position of the elastic structure 120. The guide structure 130 may be fastened to the housing 110. For example, the guide structure 130 may penetrate at least a portion of the elastic structure 120. For example, the guide structure 130 may couple the elastic structure 120 on the housing 110, together with the guide hole 111. For example, at least a portion of the guide structure 130 may reduce the elastic structure 120 from being separated from the housing 110, by passing through the elastic structure 120.

According to the above-described embodiment, the electronic device 100 for charging the wearable device 10 may increase charging efficiency of the wearable device 10 by including the elastic structure 120 that is deformable according to the size of the wearable device 10. The electronic device 100 may reduce the elastic structure 120 from being separated from the housing 110, by including the guide hole 111 and the guide structure 130.

FIG. 2A is a top plan view of an electronic device in an exemplary first state. FIG. 2B is a top plan view of an electronic device in an exemplary second state.

Referring to FIGS. 2A and 2B, an electronic device 100 for charging a wearable device 10 may include a housing 110 including a guide hole 111, and an elastic structure 120 coupled on the housing 110 and configured to supply power to the wearable device 10. According to an embodiment, the electronic device 100 may further include a guide structure 130 fastened to the housing 110.

According to an embodiment, the elastic structure 120 may include a first portion 121, a second portion 122, and a third portion 123. The first portion 121 may be at least partially disposed in the guide hole 111 of the housing 110. The second portion 122 may be rotatably coupled to the housing 110. The third portion 123 may connect the first portion 121 and the second portion 122. The third portion 123 may be deformable.

For example, the first portion 121 may be a portion coupled to the guide hole 111 of the housing 110. For example, the first portion 121 may be a portion that is at least partially disposed inside the housing 110 through the guide hole 111. For example, the first portion 121 may be partially accommodated in the guide hole 111. For example, the first portion 121 may be a portion in contact with an inner surface of the guide hole 111. For example, the first portion 121 may be a portion including one end of the elastic structure 120, but is not limited thereto. The first portion 121 may reduce the elastic structure 120 from being separated from the housing 110 as the elastic structure 120 changes, by being partially disposed in the guide hole 111.

For example, the second portion 122 may be a portion rotatable with respect to the housing 110. For example, the second portion 122 may be a portion penetrated by the guide structure 130 fastened to the housing 110. For example, the second portion 122 may be rotatably coupled on the housing 110 by the guide structure 130. For example, the second portion 122 may be a portion spaced apart from the first portion 121 that is at least partially disposed in the guide hole 111. For example, the second portion 122 may surround at least a portion of the guide structure 130 passing through the elastic structure 120.

For example, the third portion 123 may be a portion extending from the first portion 121 to the second portion 122. For example, the third portion 123 may be a portion configured to be at least partially in contact with the wearable device 10. For example, the third portion 123 may be a portion that expands outward or shrinks inward with respect to the second portion 122 configured to rotate with respect to the housing 110 by being deformed. For example, the third portion 123 may be a portion configured to supply power to the wearable device 10. The elastic structure 120 may be changed to correspond to various sizes of the wearable device 10 so that the third portion 123 is in contact with the wearable device 10, by including the third portion 123 that is deformable according to a rotation of the second portion 122. The elastic structure 120 may increase charging efficiency of the wearable device 10 having various sizes, by being changeable so that the third portion 123 is in contact with the wearable device 10.

According to an embodiment, the guide structure 130 may be configured to provide the rotation axis a of the second portion 122. For example, the guide structure 130 may penetrate at least a portion of the second portion 122. The guide structure 130 may be fastened to the housing 110 by passing through the second portion 122. The guide structure 130 may provide the rotation axis a so that the second portion 122 is rotatable with respect to the housing 110 by being fastened to the housing 110.

According to an embodiment, the third portion 123 of the elastic structure 120 may be configured to change a distance d between the rotation axis a of the second portion 122 and one position p of the third portion 123, by being deformed by the rotation of the second portion 122.

For example, as the second position 122 rotates around the rotation axis a, the third portion 123 connected to the second portion 122 may be deformed. As the third position 123 is deformed, the one position p of the third position 123 may be moved with respect to the rotation axis a. As the one position p moves with respect to the rotation axis a, the distance d between the rotation axis a and the one position p may change. For example, the one position p of the third portion 123 may be moved toward the rotation axis a of the second portion 122 or may be moved toward the wearable device 10 mounted on the housing 110, according to the deformation of the third portion 123 by the rotation of the second portion 122. The third portion 123 may be configured to be in contact with the wearable device 10 having various sizes by being deformable so that the one position p is moved with respect to the rotation axis a.

According to an embodiment, the second portion 122 of the elastic structure 120 may be configured to be rotatable with respect to the housing 110 in a first rotational direction 201 and a second rotational direction 202 opposite to the first rotational direction 201. The third portion 123 may be configured to provide a plurality of states including a first state in which the distance d between the rotation axis a of the second portion 122 and the one position p of the third portion 123 is minimum and a second state in which the distance d is maximum, by the rotation of the second portion 122.

The first state of the electronic device 100 may be a state in which the distance d between the rotation axis a of the second portion 122 and the one position p of the third portion 123 is a minimum distance. For example, in the first state, the one position p may be a state farthest from the rotation axis a. For example, the first state may be a state in which the third portion 123 of the elastic structure 120 is contracted by restoring force of the elastic structure 120. For example, the first state may be a state in which the second portion 122 is rotatable in the second rotational direction 202 with respect to the rotation axis a.

The second state of the electronic device 100 may be a state in which the distance d between the rotation axis a of the second portion 122 and the one position p of the third portion 123 is a maximum distance. For example, in the second state, the one position p may be a state closest to the rotation axis a. For example, the second state may be a state in which the second portion 122 rotates in the second rotational direction 202 with respect to the housing 110, so that the third portion 123 connected to the second portion 122 is expanded. For example, the second state may be a state in which the second portion 122 is rotatable in the first rotational direction 201 with respect to the rotation axis a.

The second portion 122 is rotatable in the first rotational direction 201 and the second rotational direction 202 opposite to the first rotational direction 201, thereby providing the first state and the second state, but is not limited thereto. The second portion 122 may be configured to deform the third portion 123 connected to the second portion 122 by being rotatable in the first rotational direction 201 and the second rotational direction 202 opposite to the first rotational direction 201, thereby providing a plurality of states including the first state and the second state. For example, corresponding to the size of the wearable device 10, the second portion 122 may provide intermediate states between the first state and the second state. The electronic device 100 may deform the third portion 123 connected to the second portion 122 to correspond to each of the wearable devices 10 having various sizes, by being configured to change into a plurality of states according to the rotation of the second portion 122.

For example, referring to FIG. 2A, a first wearable device 11 may include a first through hole 11a for having a first size S1 and passing a part of the user's body (e.g., a finger). The first wearable device 11 may be mounted on the housing 110 of the electronic device 100 so that the first through hole 11a surrounds the elastic structure 120. Since the first through hole 11a of the first wearable device 11 has the first size S1 corresponding to the size of the elastic structure 120 in which the distance d between the rotation axis a and the one position p is minimum, the third portion 123 may be in contact with the inner surface of the first through hole 11a in the first state. As the third portion 123 is in contact with the inner surface of the first through hole 11a, the elastic structure 120 may increase charging efficiency of the first wearable device 11.

For example, referring to FIG. 2B, a second wearable device 12 may include a second through hole 12a having a second size S2 greater than the first size S1 and for passing a part of the user's body (e.g., a finger). The second wearable device 12 may be mounted on the housing 110 of the electronic device 100 so that the second through hole 12a surrounds the elastic structure 120. The second through hole 12a of the second wearable device 12 may have the second size S2 corresponding to the size of the elastic structure 120 in which the distance d between the rotation axis a and the one position p is maximum. The second portion 122 may be rotated in the second rotational direction 202 while being changed from the first state to the second state in order to be deformed to the size of the elastic structure 120 corresponding to the second size S2. The third portion 123 may be deformed along the second portion 122 rotated in the second rotational direction 202. The third portion 123 may be in contact with an inner surface of the second through hole 12a in the second state, by being deformed along the second portion 122. As the third portion 123 is in contact with the inner surface of the second through hole 12a, the elastic structure 120 may increase charging efficiency of the second wearable device 12.

It has been described that the state of the electronic device 100 changes to charge the first wearable device 11 and the second wearable device 12, but it is not limited thereto. The electronic device 100 may be configured to deform the third portion 123 of the elastic structure 120, for charging of each of a plurality of wearable devices including a through hole having a size between the first size S1 and the second size S2, by being configured to be changeable into the intermediate states between the first state and the second state.

According to an embodiment, the first portion 121 may be fastened to be fastened to the housing 110 through the guide hole 111. For example, unlike the illustration, the first portion 121 may be unable to move with respect to the housing 110 by being coupled to the guide hole 111. For example, the guide hole 111 may have a shape corresponding to a shape of the first portion 121 penetrating the guide hole 111. For example, as the first portion 121 is fixed to the housing 110 by the guide hole 111, the rotation axis a of the second portion 122 may be moved by the deformation of the third portion 123 connecting the first portion 121 and the second portion 122. The electronic device 100 may require a structure for the rotation axis a of the second portion 122 to be fixed with respect to the housing 110 for various user experiences of the user.

According to an embodiment, the first portion 121 may be slidable along the guide hole 111 by the rotation of the second portion 122. For example, the size of the first portion 121 disposed in the guide hole 111 may be smaller than the size of the guide hole 111. For example, the first portion 121 may be movable with respect to the housing 110 along the guide hole 111. For example, the first portion 121 may be moved along the guide hole 111 by the deformation of the third portion 123 by the rotation of the second portion 122.

For example, the first portion 121 may be configured to slide in a first direction 203 and a second direction 204 opposite to the first direction 203 by the rotation of the second portion 122. For example, the third portion 123 may be deformed by the second portion 122 that rotates in the second rotational direction 202 while changing from the first state to the second state. The third portion 123 may expand toward the wearable device 10 by the rotation of the second portion 122 in the second rotational direction 202. By the deformation of the third portion 123 by the rotation of the second portion 122 in the second rotational direction 202, the first portion 121 may be moved in the first direction 203 along the guide hole 111. For example, the third portion 123 may be deformed by the second portion 122 that rotates in the first rotational direction 201 opposite to the second rotational direction 202, while changing from the second state to the first state. The third portion 123 may contract toward the rotation axis a of the second portion 122 by the rotation of the second portion 122 in the first rotational direction 201. By the deformation of the third portion 123 by the rotation of the second portion 122 in the first rotational direction 201, the first portion 121 may be moved along the guide hole 111 in the second direction 204 opposite to the first direction 203. However, it is not limited thereto. The directions 203 and 204 in which the first portion 121 is moved are exemplary, and the first portion 121 may be configured to be slidable in a plurality of directions by the rotation of the second portion 122. The first portion 121 may reduce damage to the elastic structure 120 by the rotation of the second portion 122, by being configured to be slidable along the guide hole 111 by the rotation of the second portion 122.

According to an embodiment, the first portion 121 may be configured to fix the rotation axis a of the second portion 122 with respect to the housing 110 by moving along the guide hole 111 by the rotation of the second portion 122. For example, while changing from the first state to the second state, the first portion 121 may be configured such that the rotation axis a of the second portion 122 is not moved with respect to the housing 110, by moving in the first direction 203 along the second portion 122 rotating in the second rotational direction 202. For example, while changing from the second state to the first state, the first portion 121 may be configured such that the rotation axis a of the second portion 122 is not moved with respect to the housing 110, by moving in the second portion 204 opposite to the first direction 203 along the second portion 122 rotating in the first rotational direction 201. The elastic structure 120 may reduce damage to the second portion 122 due to the deformation of the third portion 123 and provide the various user experiences to the user of the electronic device 100, by being configured such that the rotation axis a of the second portion 122 rotatable with respect to the housing 110 is fixed with respect to the housing 110.

According to the above-described embodiment, the elastic structure 120 of the electronic device 100 may provide a plurality of states for charging the wearable device 10 of various sizes by including the second portion 122 rotatable with respect to the housing 110 on which the wearable device 10 is mounted, and the third portion 122 deformable by the rotation of the second portion 122. The elastic structure 120 may reduce damage to the elastic structure 120 due to the rotation of the second portion 122 and may provide the various user experiences to the user, by including the first portion 121 that is slidable along the guide hole 111 by the rotation of the second portion 122.

FIG. 3A is an exploded perspective view of an exemplary electronic device. FIG. 3B illustrates an exemplary electronic device of FIG. 3A.

Referring to FIGS. 3A and 3B, an electronic device 100 for charging a wearable device 10 may include a housing 110 including a guide hole 111, and an elastic structure 120 coupled on the housing 110 and configured to supply power to the wearable device 10. The elastic structure 120 may include a first portion 121 that is at least partially disposed in the guide hole 111, a second portion 122 that is rotatably coupled to the housing 110, and a third portion 123 that connects the first portion 121 and the second portion 122 and is deformable. The third portion 123 may be configured to change a distance d between a rotation axis a of the second portion 122 and one position p of the third portion 123, by being deformed by rotation of the second portion 122.

Hereinafter, an overlapping description of a configuration having the same reference numeral as a configuration described above in FIGS. 2A and 2B will be omitted.

According to an embodiment, the housing 110 may include a first frame 330, a second frame 340, and a third frame 350. For example, the first frame 330 may define a first surface 110a on which the elastic structure 120 is disposed. For example, the first frame 330 may be a portion of the housing 110 on which the wearable device 10 is mounted. For example, the first frame 330 may be a portion in which the guide hole 111 for coupling the elastic structure 120 is formed. For example, the second frame 340 may define a third surface 110c. For example, at least one electronic component of the electronic device 100 may be disposed in the second frame 340. For example, the second frame 340 may be disposed between the first frame 330 and the third frame 350. For example, the second frame 340 may couple the first frame 330 and the third frame 350. For example, the third frame 350 may define a second surface 110b for supporting the electronic device 100. For example, the third frame 350 may be spaced apart from the first frame 330 by the second frame 340 and may face the first frame 330. For example, the first frame 330 and the third frame 350 may cover at least a portion of an inner space of the second frame 340. However, it is not limited thereto, and the housing 110 may include a plurality of frames including the frames 330, 340, and 350.

According to an embodiment, the electronic device 100 may include a driving unit 310. The driving unit 310 may include a motor 311, a shaft 312, and a first gear 313 in the housing 110 for rotating the second portion 122 of the elastic structure 120. The first gear 313 may be configured to be rotated by the motor 311. The electronic device 100 may include a second gear 320 configured to be fastened to the second portion 122 and meshed with the first gear 313 so as to rotate the second portion 122 by rotation of the first gear 313.

For example, the driving unit 310 may be disposed in the housing 110. For example, the driving unit 310 may operate by receiving power from the electronic device 100. For example, the motor 311 may be configured to rotate the shaft 312 rotatably coupled to the motor 311. For example, the motor 311 may be configured to rotate the first gear 313 fastened to the shaft 312 by rotating the shaft 312. For example, the driving unit 310 may rotate the second gear 320 meshed with the first gear 313, by including the motor 311 that rotates the first gear 313. For example, the second gear 320 may be coupled to the second portion 122. The second gear 320 may be rotated in a first rotational direction 201 and a second rotational direction 202 opposite to the first rotational direction 201, by the first gear 313 rotated by the motor 311. The second gear 320 may rotate the second portion 122 of the elastic structure 120 fastened to the second gear 320 by rotating in the first rotational direction 201 and the second rotational direction 202.

According to an embodiment, the housing 110 may include a hole 115 through which at least a portion of the second portion 122 passes. For example, the second portion 122 may include a first supporting portion 122a exposed to the outside of the housing 110 and a second supporting portion 122b disposed inside the housing 110. The first supporting portion 122a may be connected to the third portion 123 of the elastic structure 120. The second supporting portion 122b may protrude into the inside of the housing 110 through the hole 115. The second supporting portion 122b may be fastened to the second gear 320 in the housing 110, by protruding into the inside of the housing 110 through the hole 115. The second supporting portion 122b may be configured to be rotated in the first rotational direction 201 and the second rotational direction 202 opposite to the first rotational direction 201 by the motor 311, by being fastened to the second gear 320 meshed with the first gear 313 rotated by the motor 311. Since the second supporting portion 122b extends from the first supporting portion 122a exposed to the outside of the housing 110, the first supporting portion 122a may be rotated in the first rotational direction 201 and the second rotational direction 202 as the second supporting portion 122b rotates. Since the first supporting portion 122a is connected to the third portion 123 of the elastic structure 120, the first supporting portion 122a may deform the third portion 123 as it rotates in the first rotational direction 201 and the second rotational direction 202. The elastic structure 120 may be configured to support the elastic structure 120 through the hole 115 by including the support portions 122a and 122b, and such that the power of the motor 311 transmits to the elastic structure 120.

According to an embodiment, the electronic device 100 may include a guide structure 130 fastened to the housing 110 to provide the rotation axis a of the second portion 122. The second portion 122 may include a through hole 122c penetrating by the guide structure 130. For example, the through hole 122c may penetrate the first supporting portion 122a and the second supporting portion 122b. For example, the through hole 122c may penetrate the hole 115, as the second supporting portion 122b penetrates the hole 115 of the housing 110. For example, the guide structure 130 may include a supporting structure 131 for supporting the elastic structure 120, and a protruding structure 132 that protrudes from the supporting structure 131 and penetrates the through hole 122c of the second portion 122. The supporting structure 131 may cover at least a portion of the elastic structure 120. The protruding structure 132 may penetrate the hole 115 of the housing 110, by passing through the through hole 122c of the second portion 122. The protruding structure 132 may be coupled to at least a portion (e.g., the second frame 340 and/or the third frame 350 of FIG. 3A) of the housing 110, by passing through the hole 115 through the through hole 122c. The guide structure 130 may provide a rotation axis a to the second portion 122 of the elastic structure 120, by being coupled to at least a portion of the housing 110 through the through hole 122c.

According to the above-described embodiment, the electronic device 100 may provide a plurality of states for charging the wearable device 10 of various sizes, by including the driving unit 310 including the motor 311 configured to rotate the second portion 122 with respect to the housing 110, and the second gear 320. The electronic device 100 may reduce the elastic structure 120 from being separated from the housing 110 and may provide various user experiences to the user, by including the guide structure 130 that provides the rotation axis a of the second portion 122.

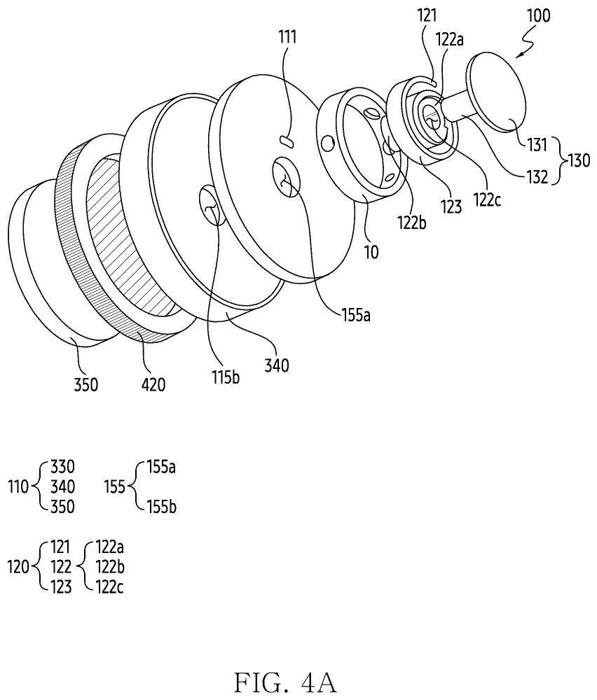

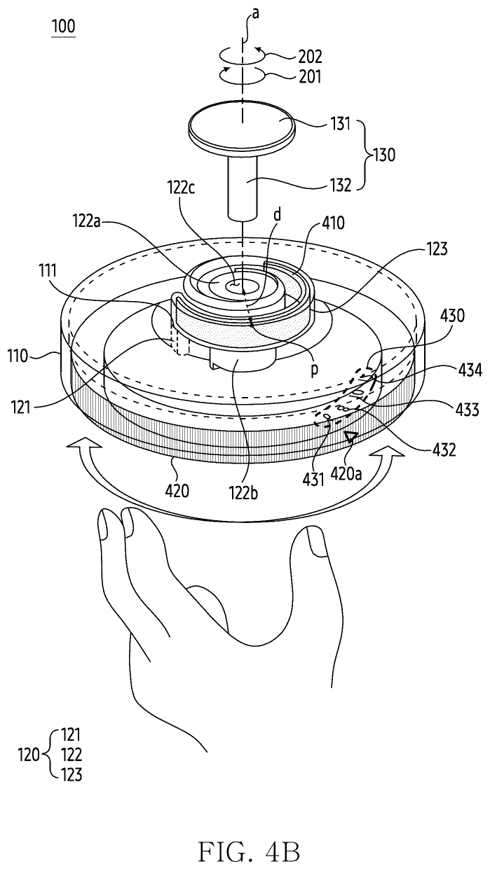

FIG. 4A is an exploded perspective view of an exemplary electronic device. FIG. 4B illustrates an exemplary electronic device of FIG. 4A.

Referring to FIGS. 4A and 4B, an electronic device 100 for charging a wearable device 10 may include a housing 110 including a guide hole 111, and an elastic structure 120 coupled on the housing 110 and configured to supply power to the wearable device 10. The elastic structure 120 may include a first portion 121 that is at least partially disposed in the guide hole 111, a second portion 122 that is rotatably coupled to the housing 110, and a third portion 123 that connects the first portion 121 and the second portion 122 and is deformable. The third portion 123 may be configured to change a distance d between a rotation axis a of the second portion 122 and one position p of the third portion 123, by being deformed by rotation of the second portion 122. According to an embodiment, the electronic device 100 may include a guide structure 130 fastened to the housing 110 to provide the rotation axis a of the second portion 122. The second portion 122 may include a through hole 122c penetrating by the guide structure 130. According to an embodiment, the housing 110 may include frames 330, 340, and 350. According to an embodiment, the second portion 122 may include a first supporting portion 122a, a second supporting portion 122b, and the through hole 122c.

According to an embodiment, the elastic structure 120 may include a coil 410 for supplying power to the wearable device 10. For example, the coil 410 may receive power through a power management module (e.g., a power management module 620 of FIG. 6) of the electronic device 100. For example, the coil 410 may be inserted into the third portion 123 of the elastic structure 120. For example, the coil 410 may be configured to allow current to flow in another coil (e.g., another coil 61 of FIG. 6), by interacting with the other coil 61 in the wearable device 10. For example, the coil 410 may be disposed in a portion of the third portion 123 spaced relatively far from the second portion 122, in order to supply power to the wearable device 10. For example, the coil 410 may be configured to allow current to flow in the other coil 61 through electromagnetic induction with the other coil 61 in the wearable device 10, by being configured to allow current to flow in the coil 410. The other coil 61 may be configured to charge a battery (e.g., a battery 62 of FIG. 6) in the wearable device 10, by being configured to allow current to flow by the coil 410.

According to an embodiment, the housing 110 may include a hole 115 through which at least a portion of the second portion 122 passes. The electronic device 100 may include a wheel 420 fastened to the second portion 122 passing through the hole 115 and rotatably coupled to the housing 110. For example, the wheel 420 may be at least partially disposed between a second frame 340 and a third frame 350 of the housing 110. For example, the wheel 420 may be coupled to the housing 110 so as to be rotatable in a first rotational direction 201 and in a second rotational direction 202 opposite to the first rotational direction 201, with respect to the housing 110. For example, the second supporting portion 122b of the second portion 122 may be coupled to the wheel 420, by penetrating the hole 115 including a first hole 115a penetrating the housing 110 and a second hole 115b connected to the first hole 115a. As the wheel 420 rotates in the first rotational direction 201 and a second rotational direction 202 opposite to the first rotational direction 201, the second supporting portion 122b of the second portion 122 fastened to the wheel 420 may rotate in the first rotational direction 201 and the second rotational direction 202. Since the second supporting portion 122b is exposed to the outside of the housing 110 and extends from the first supporting portion 122a connected to the third portion 123, the first supporting portion 122a may be rotated in the first rotational direction 201 and the second rotational direction 202 by the second supporting portion 122b. The elastic structure 120 may be configured to deform the third portion 123 connected to the second portion 122, by including the second portion 122 rotated by the rotation of the wheel 420.

According to an embodiment, the housing 110 may include a display region 430 configured to provide information related to the distance d between the rotation axis a of the second portion 122 and the one position p of the third portion 123 according to the rotation of the wheel 420 and including a plurality of display portions 431, 432, 433, and 434 spaced apart at designated intervals. The wheel 420 may include a reference display portion 420a.

For example, the display region 430 may be formed in the third frame 350 of the housing 110. For example, the display region 430 may be exposed to the outside of the housing 110. For example, the wheel 420 may include a reference display portion 420a configured to rotate with respect to the housing 110 along the wheel 420 rotating with respect to the housing 110. For example, the plurality of display portions 431, 432, 433, and 434 in the display region 430 may be disposed at positions corresponding to the reference display portion 420a rotating along the wheel 420 rotating with respect to the housing 110, respectively, by being spaced apart from each other at designated intervals. The wheel 420 may deform the third portion 123 of the elastic structure 120 coupled to the wheel 420 by rotating with respect to the housing 110. The electronic device 100 may provide information related to the distance d between the rotation axis a of the second portion 122 and the one position p of the third portion 123 according to the rotation of the wheel 420, through the reference display portion 420a formed on the wheel 420 and the plurality of display portions 431, 432, 433, and 434 formed on the housing 110. The information may include information related to the size of the wearable device 10 mounted on the electronic device 100 for charging. The housing 110 may provide information for charging the wearable device 10 to a user and may provide various user experiences to the user, by including the plurality of display portions 431, 432, 433, and 434.

According to the above-described embodiment, the electronic device 100 may provide a plurality of states for charging the wearable device 10 of various sizes, by including a wheel 420 configured to rotate the second portion 122 with respect to the housing 110. The housing 110 of the electronic device 100 may provide various user experiences to the user, by including the display region 430 including the plurality of display portions 431, 432, 433, and 434.

FIGS. 5A, 5B, and 5C are a top plan view of an exemplary electronic device.

Referring to FIGS. 5A and 5B, an electronic device 100 for charging a wearable device 10 may include a housing 110 including a guide hole 111, and an elastic structure 120 coupled on the housing 110 and configured to supply power to the wearable device 10. The elastic structure 120 may include a first portion 121 that is at least partially disposed in the guide hole 111, a second portion 122 that is rotatably coupled to the housing 110, and a third portion 123 that connects the first portion 121 and the second portion 122 and is deformable. The third portion 123 may be configured to change a distance d between a rotation axis a of the second portion 122 and one position (e.g., one position p of FIG. 2A) of the third portion 123, by being deformed by rotation of the second portion 122.

According to an embodiment, the third portion 123 may include a first region 123a connected to the second portion 122 and having a radius of curvature r1 in a first reference range 510 from the rotation axis a of the second portion 122, and a second region 123b extending from the first region 123a to the first portion 121 and having a radius of curvature r2 in a second reference range 520 greater than the radius of curvature r1 in the first reference range 510 from the rotation axis a. According to an embodiment, the first region 123a may surround at least a portion of the second portion 122. The second region 123b may surround at least a portion of the first region 123a.

For example, the first region 123a may be a region in which the distance d between the rotation axis a of the second portion 122 and the one position p of the third portion 123 is positioned in the first reference range 510. For example, the first region 123a may be a region of the third portion 123 at least partially surrounding the second portion 122. For example, the first region 123a may be a portion of the third portion 123 close to the second portion 122 based on the second portion 122. For example, the first portion 123a may be a portion connected to the second portion 122. For example, the second region 123b may be a region in which the distance d between the rotation axis a of the second portion 122 and the one position p of the third portion 123 is positioned in the second reference range 520 greater than the first reference range 510. For example, the second region 123b may be a region that partially surrounds the first region 123a of the third portion 123. For example, the second region 123b may be a portion connected to the first portion 121. For example, the first region 123a partially surrounding the second portion 122 and the second region 123b partially surrounding the first region 123a may have a spiral shape, but is not limited thereto.

According to an embodiment, the elastic structure 120 may include a coil 410 for supplying power to the wearable device 10. The coil 410 may be disposed in the second region 123b of the third portion 123. For example, the coil 410 may surround at least a portion of the first region 123a of the third portion 123, by being disposed in the second region 123b of the third portion 123. For example, in case that the wearable device 10 is mounted on the housing 110 for charging, the coil 410 may be disposed adjacent to the wearable device 10 among the second portion 122 and the wearable device 10. The coil 410 may increase charging efficiency of the wearable device 10, by being disposed in the second region 123b. The coil 410 may reduce overlapping of the coil 410 according to a shape of the elastic structure 120 and may reduce damage to the electronic device 100 due to the coil 410, by not being disposed in the first region 123a among the first region 123a and the second region 123b.

For example, the wearable device 100 may include protrusions 51, 52, and 53 for a sensor module in the wearable device 10, and a power supply region 10a for charging. In the power supply region 10a, another coil (e.g., another coil 61 of FIG. 6) for charging the wearable device 10 and a battery (e.g., a battery 62 of FIG. 6) may be disposed. The first protrusion 51 among the protrusions 51, 52, and 53 of the wearable device 10 may face the power supply region 10a. The coil 410 may be configured to charge the wearable device 10 through the coil 410 and the power supply region 10a in case that an angle between a central axis X connecting the first protrusion 51 and the rotation axis a of the second portion 122 and a fixing axis C connecting the rotation axis a of the second portion 122 and the coil 410 is positioned in a range b, by being positioned in the second region 123b of the third portion 123. A user of the wearable device 10 may be guided to a position of a charging region 550 or the power supply region 10a through the first protrusion 51. The coil 410 may provide convenience for charging the wearable device 10 to the user, by being configured to charge the wearable device 10 even if the angle between the central axis X and the fixing axis C is positioned in the range b.

According to an embodiment, the housing 110 may include the charging region 550 in which the elastic structure 120 is disposed. For example, the charging region 550 may be a region that overlaps the elastic structure 120 when the housing 110 is viewed from above. For example, the charging region 550 may be a region on which the wearable device 10 is mounted among the housing 110. For example, the charging region 550 may be a portion in contact with the wearable device 10, while the wearable device 10 is charged through the electronic device 100. The electronic device 100 may control the elastic structure 120 so that at least a portion of the elastic structure 120 is deformed by using the charging region 550. Controlling of the deformation of the elastic structure 120 by the electronic device 100 will be described later in FIG. 6.

According to the above-described embodiment, the elastic structure 120 of the electronic device 100 may reduce damage to the electronic device 100 due to the coil 410 and may increase charging efficiency of the wearable device 10, by including the coil 410 disposed in the second region 123b among the first region 123a and the second region 123b of the third portion 123.

FIG. 6 is a block diagram of an exemplary electronic device.

Referring to FIG. 6, an electronic device 100 for charging a wearable device 10 may include a housing (e.g., a housing 110 of FIG. 1A) including a guide hole (e.g., a guide hole 111 of FIG. 1A), and an elastic structure 120 coupled on the housing 110 and configured to supply power to the wearable device 10. The elastic structure 120 may include a first portion 121 that is at least partially disposed in the guide hole 111, a second portion 122 that is rotatably coupled to the housing 110, and a third portion 123 that connects the first portion 121 and the second portion 122 and is deformable. The third portion 123 may be configured to change a distance (e.g., a distance d of FIG. 2A) d between a rotation axis (e.g., a rotation axis a of FIG. 2A) of the second portion 122 and one position (e.g., one position p of FIG. 2A) of the third portion 123, by being deformed by rotation of the second portion 122. According to an embodiment, the electronic device 100 may include a driving unit 310 including a motor 311 in the housing 110 for rotating the second portion 122.

According to an embodiment, the electronic device 100 may further include a processor 610. The housing 110 may include a charging region (e.g., the charging region 550 of FIG. 5A) in which the elastic structure 120 is disposed. The processor 610 may be configured to identify whether the elastic structure 120 is in contact with the wearable device 10, based on identifying the wearable device 10 on the charging region 550. For example, the processor 610 may be configured to identify the wearable device 10 in contact with the charging region 550. The processor 610 may be configured to identify whether the elastic structure 120 is in contact with the wearable device 10, based on identifying the wearable device 10 disposed on the charging region 550. For example, the processor 610 may be configured to identify whether the third portion 123 is in contact with the wearable device 10, through the coil 410 included in the third portion 123 and another coil 61 in the wearable device 10.

According to an embodiment, the processor 610 may be configured to control the motor 311 to rotate the second portion 122 of the elastic structure 120, while identifying that the elastic structure 120 is not in contact with the wearable device 10. For example, the processor 610 may be configured to identify that the elastic structure 120 is not in contact with the wearable device 10, based on identifying that no induced current flows between the coil 410 and the other coil 61 in the wearable device 10. For example, the processor 610 may be configured to supply power to the motor 311 in the driving unit 310 through a power management module 620, while identifying that the elastic structure 120 is not in contact with the wearable device 10. The processor 610 may be configured such that the second portion 122 is rotated by the motor 311, by supplying power to the motor 311 through the power management module 620. The processor 610 may be configured to deform the third portion 123 connected to the second portion 122, by rotating the second portion 122 through the motor 311, while identifying that the elastic structure 120 is not in contact with the wearable device 10.

According to an embodiment, the processor 610 may be configured to bypass the rotation of the second portion 122 by the motor 311, while identifying that the elastic structure 120 is in contact with the wearable device 10. For example, the processor 610 may be configured to identify that elastic structure 120 and wearable device 10 are in contact, based on identifying that an induced current flows between the coil 410 and the other coil 61 in the wearable device 10. The processor 610 may be configured to bypass the deformation of the third portion 123 connected to the second portion 122, by being configured to bypass the rotation of the second portion 122 by the motor 311, while identifying that the elastic structure 120 is in contact with the wearable device 10. The coil 410 may be configured to charge a battery 62 in a power supply region 10a, by being configured to allow the induced current to flow to the other coil 61 in the power supply region 10a of the wearable device 10.

According to the above-described embodiment, the electronic device 100 may be configured to deform the elastic structure 120 for charging the wearable device 10 of various sizes, by including the processor 610 configured to control the motor 311. The electronic device 100 may provide various user experiences to a user, by including the processor 610 configured to control the motor 311.

According to the above-described embodiment, an electronic device (e.g., an electronic device 100 of FIG. 1A) for charging a wearable device (e.g., a wearable device 10 of FIG. 1A) may comprise a housing (e.g., a housing 110 of FIG. 1A) including a guide hole (e.g., a guide groove 111 of FIG. 1A), and an elastic structure (e.g., an elastic structure 120 of FIG. 1A) coupled on the housing and configured to supply power to the wearable device. The elastic structure may include a first portion (e.g., a first portion 121 of FIG. 2A) at least partially disposed in the guide hole, a second portion (e.g., a second portion 122 of FIG. 2A) rotatably coupled with the housing, and a third portion (e.g., a third portion 123 of FIG. 2A), which is deformable, connecting the first portion and the second portion. The third portion may be deformed by a rotation of the second portion such that the third portion is configured to change a distance (e.g., a distance d of FIG. 2A) between a rotation axis (e.g., a rotation axis a of FIG. 2A) of the second portion and one position (e.g., one position p of FIG. 2A) of the third portion. According to the above-mentioned embodiment, the elastic structure may provide a plurality of states for charging the wearable device of various sizes by including the second portion rotatable with respect to the housing and the third portion deformable by the rotation of the second portion. The above-mentioned embodiment may have various effects including the above-mentioned effect.

According to an embodiment, the second portion may be configured to be rotatable with respect to the housing in a first rotational direction (e.g., a first rotational direction 201 of FIG. 2B) and a second rotational direction (e.g., a second rotational direction 202 of FIG. 2B) opposite to the first rotational direction. The third portion may be configured to provide a plurality of states including a first state in which the distance is minimum, and a second state in which the distance is maximum by the rotation of the second portion. According to the above-mentioned embodiment, the elastic structure may provide a plurality of states for charging the wearable device of various sizes by including the second portion rotatable with respect to the housing and the third portion deformable by the rotation of the second portion. The above-mentioned embodiment may have various effects including the above-mentioned effect.

According to an embodiment, the third portion may include a first region (e.g., a first region 123a of FIG. 5A) connected to the second portion and having a radius of curvature (e.g., r1 of FIG. 5A) within a first reference range (e.g., a first reference range 510 of FIG. 5A) from the rotation axis of the second portion, and a second region (e.g., a second region 123b of FIG. 5A) extending from the first region to the first portion and having a radius of curvature (e.g., r2 of FIG. 5A) within a second reference range (e.g., a second reference range 520 of FIG. 5A) from the rotation axis greater than the radius of curvature within the first reference range. According to the above-mentioned embodiment, the elastic structure may provide a plurality of states for charging the wearable device of various sizes by including the second portion rotatable with respect to the housing and the third portion deformable by the rotation of the second portion. The above-mentioned embodiment may have various effects including the above-mentioned effect.

According to an embodiment, the elastic structure may further include a coil (e.g., a coil 410 of FIG. 4B) for supplying power to the wearable device disposed in the second region. According to the above-mentioned embodiment, the elastic structure may reduce damage to the electronic device due to the coil and may increase charging efficiency of the wearable device, by including the coil disposed within the second region. The above-mentioned embodiment may have various effects including the above-mentioned effect.

According to an embodiment, the first region may surround at least a portion of the second portion. The second region may surround at least a portion of the first region. According to the above-mentioned embodiment, the elastic structure may reduce damage to the electronic device due to the coil and may increase charging efficiency of the wearable device, by being configured such that the second region in which the coil is disposed surrounds at least a portion of the first region. The above-mentioned embodiment may have various effects including the above-mentioned effect.

The electronic device according to an embodiment may further comprise a motor (e.g., a motor 311 of FIG. 3A) in the housing, a first gear (e.g., a first gear 313 of FIG. 3A) configured to be rotated by the motor, and a second gear (e.g., a second gear 320 of FIG. 3A) fastened to the second portion and meshed with the first gear so as to rotate the second portion by rotation of the first gear. According to the above-mentioned embodiment, the elastic structure may rotate the second portion and may provide various user experiences to a user, by including the motor. The above-mentioned embodiment may have various effects including the above-mentioned effect.

The electronic device according to an embodiment may further comprise a guide structure (e.g., a guide structure 130 of FIG. 1A) fastened to the housing to provide the rotation axis of the second portion. The second portion may include a through hole (e.g., a through hole 122c of FIG. 3A) penetrated by the guide structure. According to the above-mentioned embodiment, the electronic device may reduce the elastic structure from being separated from the housing by including the guide structure. The above-mentioned embodiment may have various effects including the above-mentioned effect.

According to an embodiment, the housing may further include a hole (e.g., a hole 115 of FIG. 3A) through which at least a portion of the second portion passes. The electronic device may further comprise a wheel (e.g., a wheel 420 of FIG. 4A) fastened to the second portion passing through the hole and rotatably coupled to the housing. According to the above-mentioned embodiment, the electronic device may provide various user experiences to the user by including the wheel. The above-mentioned embodiment may have various effects including the above-mentioned effect.

According to an embodiment, the housing may further include a display region (e.g., a display region 430 of FIG. 4B) configured to provide information related to the distance according to the rotation of the wheel and including a plurality of display portions (e.g., a plurality of display portions 431, 432, 433, and 434 of FIG. 4B) spaced apart at designated intervals. According to the above-mentioned embodiment, the housing may provide various user experiences to the user by including the display region. The above-mentioned embodiment may have various effects including the above-mentioned effect.

According to an embodiment, the first portion may be slidable along the guide hole by the rotation of the second portion. According to the above-mentioned embodiment, the first portion may reduce damage to the elastic structure due to the rotation of the second portion and may provide various user experiences to the user, by being slidable along the guide hole. The above-mentioned embodiment may have various effects including the above-mentioned effect.

According to an embodiment, the first portion may be configured to fix the rotation axis of the second portion with respect to the housing by moving along the guide hole by the rotation of the second portion. According to the above-mentioned embodiment, the first portion may provide various user experiences to the user by fixing the rotation axis through the guide hole. The above-mentioned embodiment may have various effects including the above-mentioned effect.

According to an embodiment, the first portion may be fastened to the housing through the guide hole. According to the above-mentioned embodiment, the first portion may reduce the elastic structure from being separated from the housing, by being fastened to the housing through the guide hole. The above-mentioned embodiment may have various effects including the above-mentioned effect.

According to an embodiment, the electronic device may further comprise a motor for rotating the second portion in the housing, and a processor (e.g., a processor 610 of FIG. 6). The housing may further include a charging region (e.g., the charging region 550 of FIG. 5A) on which the elastic structure is disposed. The processor may be configured to identify whether the elastic structure and the wearable device are contacting each other based on identifying the wearable device on the charging region. The processor may be configured to control the motor to rotate the second portion while identifying that the elastic structure is not in contact with the wearable device. The processor may be configured to bypass the rotation of the second portion by the motor while identifying that the elastic structure is in contact with the wearable device. According to the above-mentioned embodiment, the electronic device may provide various user experiences to the user by including the processor configured to control the motor. The above-mentioned embodiment may have various effects including the above-mentioned effect.

According to an embodiment, the elastic structure may include at least one of rubber, and spring. According to the above-mentioned embodiment, the elastic structure may provide a plurality of states for charging the wearable device of various sizes by including at least one of the rubber and the spring. The above-mentioned embodiment may have various effects including the above-mentioned effect.

According to an embodiment, the elastic structure may have spiral shape. The elastic structure may provide a plurality of states to the electronic device for charging the wearable device of various sizes and may provide various user experiences to the user. The above-mentioned embodiment may have various effects including the above-mentioned effect.

According to an embodiment, an electronic device for charging wearable device may comprise a housing including a guide hole, and an elastic structure coupled on the housing and configured to supply power to the wearable device. The elastic structure may include a first portion at least partially disposed in the guide hole, and a second portion rotatably coupled with the housing. The elastic structure may include a third portion connecting the first portion and the second portion and including a first region connected to the second portion and having a radius of curvature within a first reference range from the rotation axis of the second portion, and a second region extending from the first region to the first portion and having a radius of curvature within a second reference range from the rotation axis greater than the radius of curvature within the first reference range. The third portion may be deformed by a rotation of the second portion such that the third portion is configured to change a distance between a rotation axis of the second portion and one position of the third portion is changeable. The first portion may be slidable along the guide hole by the rotation of the second portion. According to the above-mentioned embodiment, the elastic structure may provide a plurality of states for charging the wearable device of various sizes by including the second portion rotatable with respect to the housing and the third portion deformable by the rotation of the second portion. The first portion may reduce damage to the elastic structure due to the rotation of the second portion and may provide various user experiences to the user, by being slidable along the guide hole. The above-mentioned embodiment may have various effects including the above-mentioned effect.

According to an embodiment, the second portion may be configured to rotatable with respect to the housing in a first rotational direction and a second rotational direction opposite to the first rotational direction. The third portion may be configured to provide a plurality of states including a first state in which the distance is minimum, and a second state in which the distance is maximum by the rotation of the second portion. According to the above-mentioned embodiment, the elastic structure may provide a plurality of states for charging the wearable device of various sizes by including the second portion rotatable with respect to the housing and the third portion deformable by the rotation of the second portion. The above-mentioned embodiment may have various effects including the above-mentioned effect.

According to an embodiment, the first region may surround at least a portion of the second portion. The second region may surround at least a portion of the first region. According to the above-mentioned embodiment, the elastic structure may reduce damage to the electronic device due to the coil and may increase charging efficiency of the wearable device, by being configured such that the second region in which the coil is disposed surrounds at least a portion of the first region. The above-mentioned embodiment may have various effects including the above-mentioned effect.

The electronic device according to an embodiment may further comprise a motor in the housing, a first gear configured to be rotated by the motor, and a second gear fastened to the second portion and meshed with the first gear so as to rotate the second portion by rotation of the first gear. According to the above-mentioned embodiment, the elastic structure may rotate the second portion and may provide various user experiences to a user, by including the motor. The above-mentioned embodiment may have various effects including the above-mentioned effect.

According to an embodiment, the first portion may be configured to fix the rotation axis of the second portion with respect to the housing by moving along the guide hole by the rotation of the second portion. According to the above-mentioned embodiment, the first portion may provide various user experiences to the user by fixing the rotation axis through the guide hole. The above-mentioned embodiment may have various effects including the above-mentioned effect.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., program) including one or more instructions that are stored in a storage medium (e.g., internal memory or external memory) that is readable by a machine (e.g., the electronic device 100). For example, a processor (e.g., the processor 610) of the machine (e.g., the electronic device 100) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

No claim element is to be construed under the provisions of 35 U.S.C. § 112, sixth paragraph, unless the element is expressly recited using the phrase “means for” or “means”.

What is claimed is:

1. An electronic device for charging a wearable device, the electronic device comprising:
a housing including a guide hole; and
an elastic structure coupled on the housing and configured to supply power to the wearable device,
wherein, the elastic structure includes:
a first portion at least partially disposed in the guide hole;
a second portion rotatably coupled with the housing; and
a third portion, which is deformable, connecting the first portion and the second portion, and
wherein, the third portion is deformed by a rotation of the second portion such that the third portion is configured to change a distance between a rotation axis of the second portion and one position of the third portion.

2. The electronic device of claim 1,
wherein, the second portion is configured to be rotatable with respect to the housing in a first rotational direction and a second rotational direction opposite to the first rotational direction, and
wherein, the third portion is configured to provide a plurality of states including a first state in which the distance is minimum, and a second state in which the distance is maximum by the rotation of the second portion.

3. The electronic device of claim 1, wherein, the third portion includes:
a first region connected to the second portion and having a radius of curvature within a first reference range from the rotation axis of the second portion; and
a second region extending from the first region to the first portion and having a radius of curvature within a second reference range from the rotation axis greater than the radius of curvature within the first reference range.

4. The electronic device of claim 3, wherein, the elastic structure further includes a coil for supplying power to the wearable device disposed in the second region.

5. The electronic device of claim 3,
wherein, the first region surrounds at least a portion of the second portion, and
wherein, the second region surrounds at least a portion of the first region.

6. The electronic device of claim 1, further comprising:
a motor in the housing;
a first gear configured to be rotated by the motor; and
a second gear fastened to the second portion and meshed with the first gear so as to rotate the second portion by rotation of the first gear.

7. The electronic device of claim 1, further comprising:
a guide structure fastened to the housing to provide the rotation axis of the second portion,
wherein, the second portion includes a through hole penetrated by the guide structure.

8. The electronic device of claim 1,
wherein, the housing further includes a hole through which at least a portion of the second portion passes, and
wherein, the electronic device further comprising a wheel fastened to the second portion passing through the hole and rotatably coupled to the housing.

9. The electronic device of claim 8, wherein, the housing further includes a display region configured to provide information related to the distance according to the rotation of the wheel and including a plurality of display portions spaced apart at designated intervals.

10. The electronic device of claim 1, wherein, the first portion is slidable along the guide hole by the rotation of the second portion.

11. The electronic device of claim 10, wherein, the first portion is configured to fix the rotation axis of the second portion with respect to the housing by moving along the guide hole by the rotation of the second portion.

12. The electronic device of claim 1, wherein, the first portion is fastened to the housing through the guide hole.

13. The electronic device of claim 1, further comprising:
a motor for rotating the second portion in the housing;
at least one processor comprising processing circuitry; and
memory, comprising one or more storage mediums, storing instructions,
wherein, the housing further includes a charging region on which the elastic structure is disposed,
wherein, the instructions, when executed by the at least one processor individually or collectively, cause the electronic device to:
identify whether the elastic structure and the wearable device are contacting each other based on identifying the wearable device on the charging region;
control the motor to rotate the second portion while identifying that the elastic structure is not in contact with the wearable device; and
bypass the rotation of the second portion by the motor while identifying that the elastic structure is in contact with the wearable device.

14. The electronic device of claim 1, wherein, the elastic structure includes at least one of rubber, and spring.

15. The electronic device of claim 1, wherein, the elastic structure has spiral shape.

16. An electronic device for charging wearable device, the electronic device comprising:
a housing including a guide hole; and
an elastic structure coupled on the housing and configured to supply power to the wearable device,
wherein, the elastic structure includes:
a first portion at least partially disposed in the guide hole;
a second portion rotatably coupled with the housing; and
a third portion connecting the first portion and the second portion and including a first region connected to the second portion and having a radius of curvature within a first reference range from a rotation axis of the second portion, and a second region extending from the first region to the first portion and having a radius of curvature within a second reference range from the rotation axis greater than the radius of curvature within the first reference range,
wherein, the third portion is deformed by a rotation of the second portion such that the third portion is configured to change a distance between a rotation axis of the second portion and one position of the third portion is changeable, and
wherein, the first portion is slidable along the guide hole by the rotation of the second portion.

17. The electronic device of claim 16,
wherein, the second portion is configured to rotatable with respect to the housing in a first rotational direction and a second rotational direction opposite to the first rotational direction, and
wherein, the third portion is configured to provide a plurality of states including a first state in which the distance is minimum, and a second state in which the distance is maximum by the rotation of the second portion.

18. The electronic device of claim 16,
wherein, the first region surrounds at least a portion of the second portion, and
wherein, the second region surrounds at least a portion of the first region.

19. The electronic device of claim 16, further comprising:
a motor in the housing;
a first gear configured to be rotated by the motor; and
a second gear fastened to the second portion and meshed with the first gear so as to rotate the second portion by rotation of the first gear.

20. The electronic device of claim 16, wherein, the first portion is configured to fix the rotation axis of the second portion with respect to the housing by moving along the guide hole by the rotation of the second portion.
